(19) United States
(12) Patent Application Publication
(10) Pub. No.: US 2026/0246168 A1
(43) Pub. Date: Aug. 20, 2026

(54) TERMINAL BLOCK

(71) Applicant: Yazaki Corporation, Tokyo (JP)

(72) Inventors: Sota ARAI, Shizuoka (JP); Masato AKINO, Shizuoka (JP); Yasuhiro TANAKA, Shizuoka (JP); Yasuhiro OTSUTA, Shizuoka (JP); Masatoshi YAMADA, Shizuoka (JP); Yusuke TSUTAGAWA, Shizuoka (JP)

(73) Assignee: Yazaki Corporation, Tokyo (JP)

(21) Appl. No.: 19/449,582

(22) Filed: Jan. 15, 2026

(30) Foreign Application Priority Data
Feb. 14, 2025 (JP) 2025-022053

(51) Int. Cl. H01R 9/18; H01R 9/22; H01R 43/00

(52) U.S. Cl. CPC H01R 9/18; H01R 9/226; H01R 43/005; H01R 2201/26

(57) ABSTRACT

A terminal block includes a housing that holds a terminal, a packing that is assembled to the housing and performs waterproofing between the housing and a fixed object, and a fastening member that fastens the housing to a fixed object, in which the packing is accommodated in an accommodation groove formed in the housing, and presses a portion protruding from the accommodation groove against the fixed object to perform the waterproofing, and the accommodation groove is formed deeper as a depth along a pressing direction of the packing is closer to the fastening member.

### CROSS-REFERENCE TO RELATED APPLICATION(S)

The present application claims priority to and incorporates by reference the entire contents of Japanese Patent Application No. 2025-022053 filed in Japan on February 14, 2025.

### BACKGROUND OF THE INVENTION

### 1. Field of the Invention

The present invention relates to a terminal block.

### 2. Description of the Related Art

Conventionally, as a terminal block, for example, as described in JP 2023-171078 A, a terminal block including a housing for holding a terminal and a packing assembled to the housing is known. The terminal block is assembled to a fixed object by fastening the housing to the fixed object by a fastening member while performing waterproofing by pressing the packing against the fixed object.

In such a terminal block, there is room for improvement in that waterproofing by packing may not be appropriately performed. For example, when the housing is fastened to the fixed object, the pressing force of the packing tends to decrease at a position far from the fastening position. That is, there is a concern that the pressing force of the packing decreases at a position farther from the fastening position as compared with a position close to the fastening position, and the waterproofing function deteriorates. Meanwhile, when the fastening force is increased to increase the pressing force of the packing at a position far from the fastening position, the reaction force of the pressing increases in the housing near the fastening portion, and the housing is required to have high strength.

### SUMMARY OF THE INVENTION

Therefore, an object of the present invention is to provide a terminal block capable of appropriately performing waterproofing by packing.

In order to achieve the above mentioned object, a terminal block according to one aspect of the present invention includes a housing that holds a terminal; a packing that is assembled to the housing and performs waterproofing between the housing and a fixed object; and a fastening member that fastens the housing to a fixed object, wherein the packing is accommodated in an accommodation groove formed in the housing, and presses a portion protruding from the accommodation groove against the fixed object to perform the waterproofing, and the accommodation groove is formed deeper as a depth along a pressing direction of the packing is closer to the fastening member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to an embodiment;

FIG. 2 is an exploded perspective view of the terminal block according to the embodiment;

FIG. 3 is an exploded perspective view of the terminal block according to the embodiment;

FIG. 4 is a cross-sectional view of the terminal block taken along line IV-IV in FIG. 3;

FIG. 5 is a bottom view of the terminal block according to the embodiment;

FIG. 6 is a cross-sectional view of the terminal block taken along line VI-VI in FIG. 4; and

FIG. 7 is a cross-sectional view of the terminal block taken along line VII-VII in FIG. 4.

### DETAILED DESCRIPTION OF THE PREFERRED EMBODIMENTS

Hereinafter, an embodiment according to the present invention will be described in detail with reference to the drawings. Note that the present invention is not limited by this embodiment. In addition, constituent elements in the following embodiment include those that can be easily replaced by those skilled in the art or those that are substantially the same.

### Embodiment

The present embodiment relates to a terminal block. In the following description, among a first direction, a second direction, and a third direction intersecting each other, the first direction is referred to as a “depth direction X”, the second direction is referred to as a “width direction Y”, and the third direction is referred to as an “assembling direction Z”. Here, the depth direction X, the width direction Y, and the assembling direction Z are orthogonal to each other. The term “orthogonal” as used herein includes substantially orthogonal. The assembling direction Z corresponds to a direction in which a housing is assembled to a fixed object. In addition, each direction used in the following description represents a direction in a state in which each portion is assembled to each other unless otherwise specified.

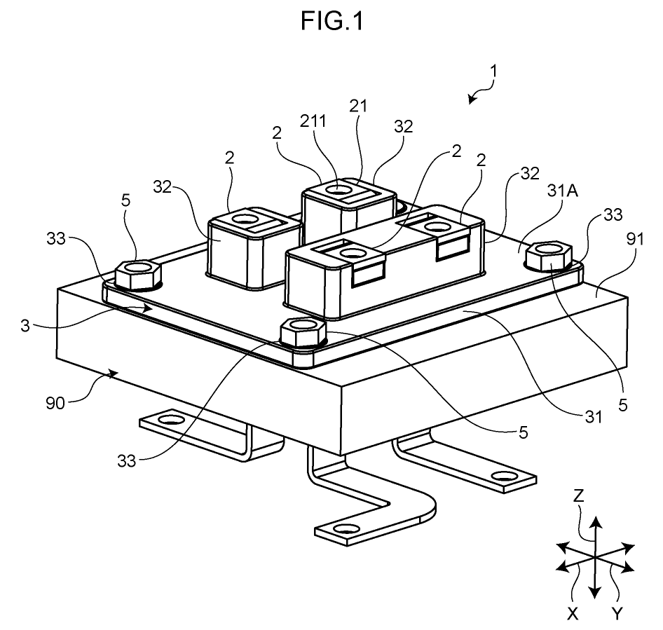

As illustrated in FIGS. 1 to 3, a terminal block 1 is a component that holds a terminal 2, and is used by being attached to a fixed object 90. The terminal block 1 is mounted on a vehicle, for example, and holds a plurality of terminals 2 arranged along a direction intersecting the assembling direction Z. Specifically, in the terminal block 1, two terminals 2 are arranged in each of the depth direction X and the width direction Y, and a total of four terminals 2 are held. The fixed object 90 is a vehicle unit mounted on the vehicle or provided in the vehicle, and is, for example, a component of the vehicle, a component, a member, or a device mounted on the vehicle. The number of terminals 2 installed may be other than four. The terminal block 1 includes a housing 3, a packing 4, and a fastening member 5.

The housing 3 is a component that holds the terminal 2 and is assembled to the fixed object 90, and is formed of an insulator, for example, formed of resin. The housing 3 has a main body portion 31 that holds the terminal 2. The main body portion 31 has a rectangular plate shape, is disposed so as to face an attachment surface 91 of the fixed object 90, and is assembled to the fixed object 90. Here, the rectangle includes substantially a rectangle. The attachment surface 91 is a surface of the fixed object 90 and extends in the depth direction X and the width direction Y. The main body portion 31 holds the terminal 2 penetrating along the assembling direction Z. The terminal 2 is a plate body formed in a band shape, and is formed of a conductor.

A surface portion 31A of the main body portion 31 is provided with a protruding portion 32. The surface portion 31A is a surface of the main body portion 31, and is a surface opposite to a back surface portion 31B facing the fixed object 90. The protruding portion 32 is a block-shaped portion protruding from the surface portion 31A. The protruding portion 32 is provided at a penetrating position of the terminal 2 and supports an end portion 21 of the terminal 2. For example, the end portion 21 of the terminal 2 is bent from the assembling direction Z toward the width direction Y to form an insertion hole 211. The terminal 2 is configured such that a fastening member (not illustrated) can be inserted into the insertion hole 211 from the assembling direction Z and fastened to the protruding portion 32. A plurality of the protruding portions 32 is provided to support one or two terminals 2. The support structure or the holding structure of the terminal 2 in the housing 3 is not limited to those described above.

A fastening hole 33 is formed in the main body portion 31. The fastening hole 33 is a hole for inserting the fastening member 5, is formed between the surface portion 31A and the back surface portion 31B of the main body portion 31, and penetrates the main body portion 31 along the assembling direction Z. The fastening holes 33 are formed, for example, at four corner portions of the main body portion 31 having a rectangular shape. A fastening hole 93 is formed in the attachment surface 91 of the fixed object 90. The fastening hole 93 is a hole for inserting the fastening member 5 penetrating the main body portion 31, and is formed at a position corresponding to the fastening hole 33.

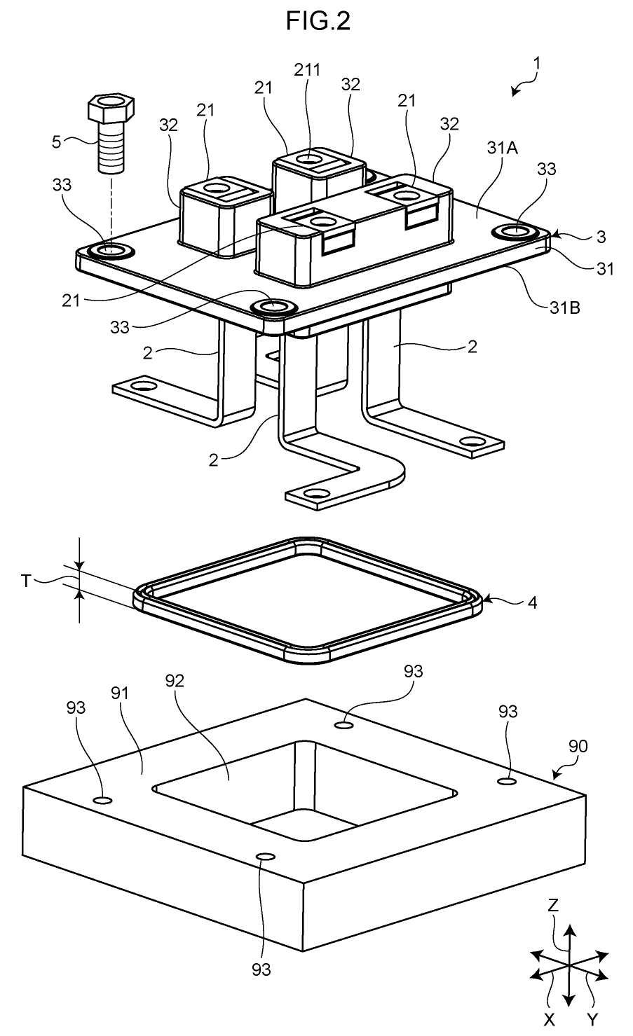

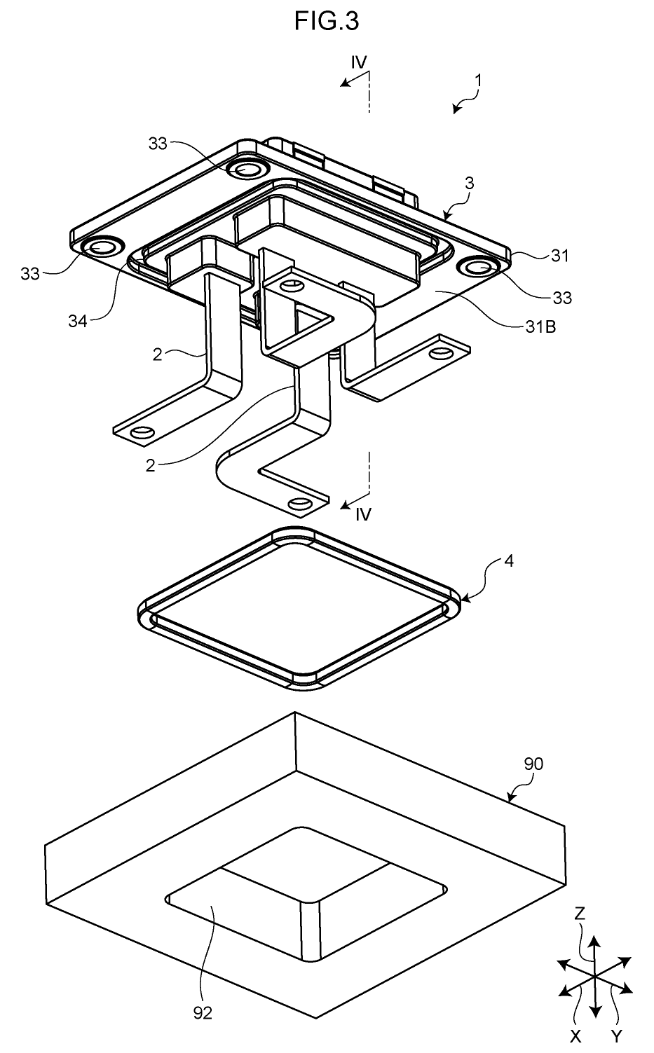

The fastening member 5 is a member that fastens the terminal block 1 to the fixed object 90, and for example, a bolt is used. The fastening member 5 is provided to penetrate the main body portion 31 of the housing 3, and performs fastening so as to press the terminal block 1 against the fixed object 90. The fastening member 5 may be a stud bolt or the like protruding from the fixed object 90 and penetrating the main body portion 31. In FIGS. 2 and 3, the fastening member 5 is inserted into each fastening hole 33 and installed, but illustration of the fastening member 5 is appropriately omitted for convenience of description.

The terminal 2 is formed to extend from the back surface portion 31B and bend. That is, the terminal 2 is electrically connected inside the fixed object 90 and is formed to be bent as necessary. Note that the terminal 2 may extend linearly. The fixed object 90 forms an opening 92 through which the terminal 2 is inserted.

The packing 4 is a waterproofing member that performs waterproofing between the housing 3 and the fixed object 90, and is made of an elastically deformable material. For example, the packing 4 is formed in an annular shape, for example, formed in a rectangular shape according to the shape of the main body portion 31 of the housing 3, and provided so as to surround the opening 92.

The packing 4 is accommodated and held in an accommodation groove 34 formed in the housing 3. The accommodation groove 34 is a groove formed by recessing the back surface portion 31B of the main body portion 31 in the assembling direction Z. The accommodation groove 34 is formed in a shape corresponding to the packing 4, and is formed in, for example, a rectangular shape. The accommodation groove 34 is formed so as to surround the terminal 2 penetrating the main body portion 31. The packing 4 is formed to be thicker than the depth of the accommodation groove 34, and is assembled to protrude from the accommodation groove 34 in a state of being accommodated in the accommodation groove 34. In the packing 4, a portion protruding from the accommodation groove 34 abuts on the attachment surface 91 of the fixed object 90 when the terminal block 1 is assembled to the fixed object 90, and presses the attachment surface 91 to perform the waterproofing.

For example, the packing 4 is formed to have the same thickness T along the pressing direction in the extending direction. That is, the packing 4 is formed such that the thickness T in the assembling direction Z is the same in the depth direction X and the width direction Y, and does not change depending on the position in the extending direction. Here, the same thickness includes substantially the same thickness.

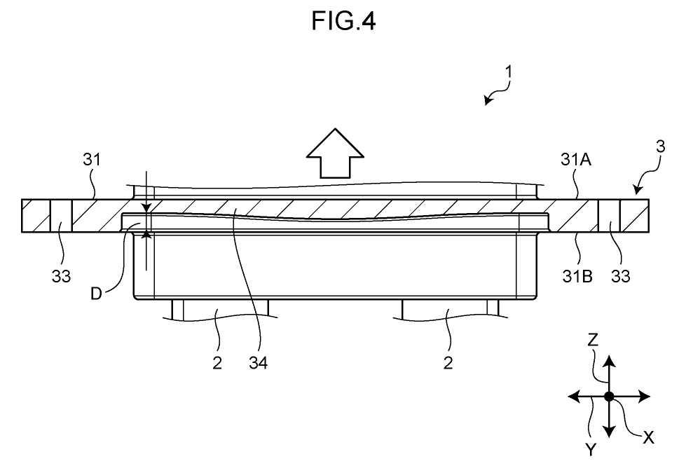

As illustrated in FIG. 4, the accommodation groove 34 is formed such that a depth D along the pressing direction is different in the extending direction. The pressing direction is the same as the assembling direction Z. The depth D of the accommodation groove 34 is formed deeper toward the fastening member 5. In other words, the depth D of the accommodation groove 34 is formed shallower as the distance from the fastening member 5 increases. For example, the depth D of the accommodation groove 34 is gradually shallower from the end portion close to the fastening member 5 toward the central portion, and is shallowest at the central portion.

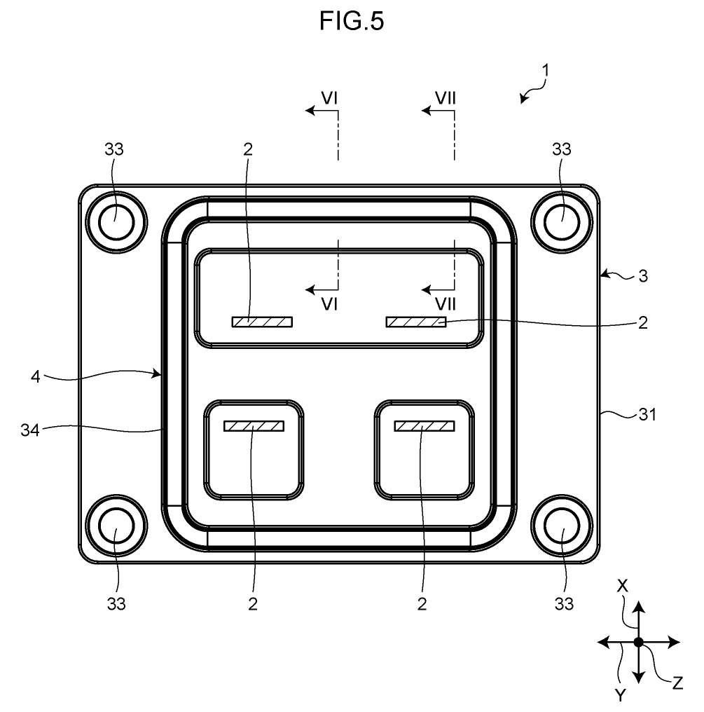

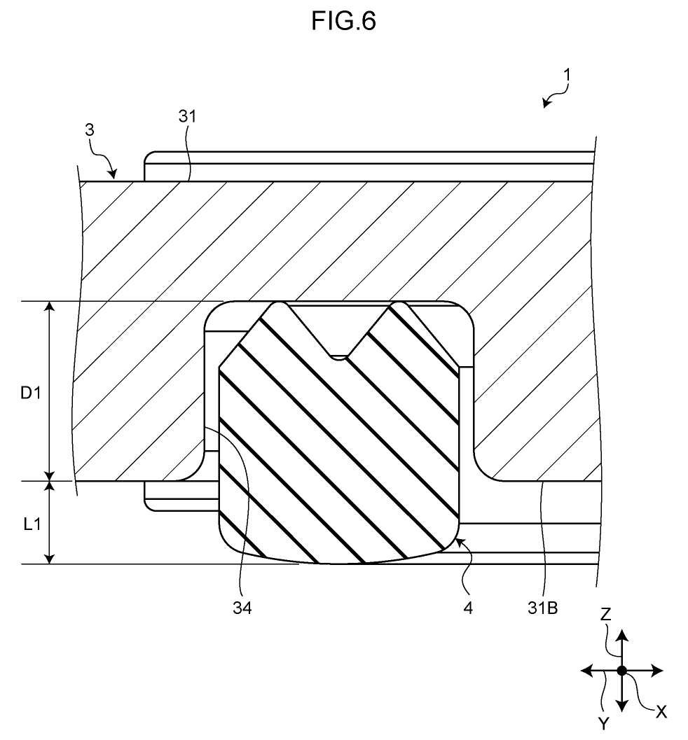

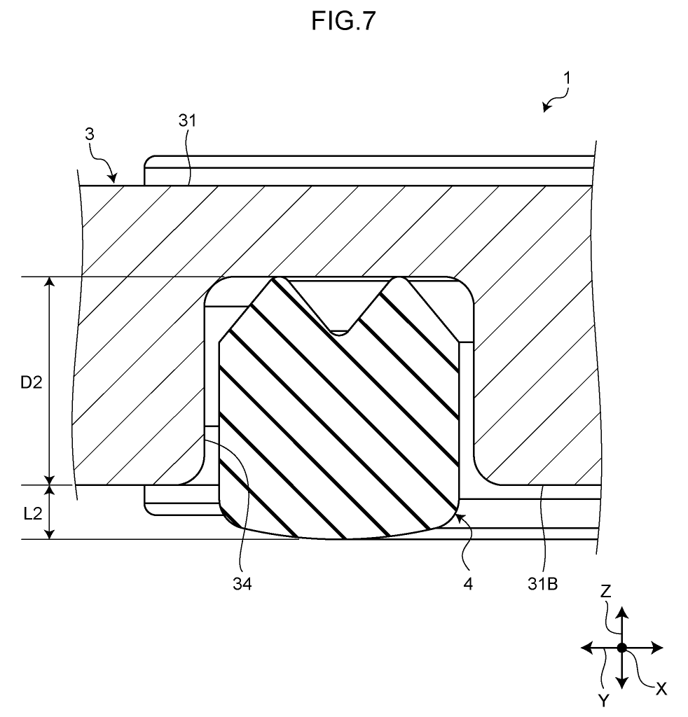

As illustrated in FIG. 5, in the terminal block 1 according to the present embodiment, a fastening hole 33 is formed in the vicinity of a corner portion of the rectangular accommodation groove 34, and the fastening member 5 is installed in each fastening hole 33. For this reason, in a side portion between the corner portion and the corner portion of the accommodation groove 34, the depth D becomes shallower from the end portion toward the central portion. That is, as illustrated in FIGS. 6 and 7, when the depth D at the central portion of the accommodation groove 34 is a depth D1 (FIG. 6), and the depth D at the end portion of the accommodation groove 34 is a depth D2 (FIG. 7), the depth D is set such that D1<D2. In FIG. 4, in the accommodation groove 34, only one side portion between the corner portion and the corner portion is illustrated, but also in the other side portions, the depth D decreases from the end portion in the vicinity of the corner portion toward the central portion.

In the terminal block 1, as described above, the thickness of the packing 4 in the pressing direction is the same in the extending direction of the packing 4. That is, the thickness of the packing 4 does not change in the depth in the direction (for example, depth direction X and width direction Y) in which the packing 4 extends. Therefore, since the depth D of the accommodation groove 34 is different in the extending direction, the protrusion length of the packing 4 protruding from the accommodation groove 34 is different in the extending direction. For example, at the side portion between the corner portion and the corner portion of the packing 4, the protrusion length becomes longer from the end portion toward the central portion. That is, as illustrated in FIGS. 6 and 7, when the protrusion length of a pressing portion 41 at the central portion of the packing 4 is L1 (FIG. 6), and the protrusion length of the pressing portion 41 at the end portion of the packing 4 is L2 (FIG. 7), the protrusion length of the pressing portion 41 is set such that L1>L2.

In the accommodation groove 34, a difference (D2-D1) between the depth of the depth D2 of the end portion in the vicinity of the fastening member 5 and the depth of the depth D1 of the central portion away from the fastening member 5 is set according to the rigidity of the housing 3. The difference in depth is an absolute value of the difference. For example, the difference between the depth of the depth D2 of the end portion in the vicinity of the fastening member 5 and the depth of the depth D1 of the central portion away from the fastening member 5 is set to be smaller as the rigidity of the housing 3 is higher and larger as the rigidity of the housing is lower. That is, since the bending of the housing 3 decreases as the rigidity of the housing 3 increases, the amount of bending of the central portion of the main body portion 31 in the assembling direction Z decreases when the terminal block 1 is fastened to the fixed object 90 (see an upward arrow in FIG. 4). Therefore, even when the difference between the depth of the depth D2 of the end portion in the vicinity of the fastening member 5 and the depth of the depth D1 of the central portion away from the fastening member 5 is small, the pressing force of the packing 4 can be easily made uniform, and the waterproofing by the packing 4 can be appropriately performed. Meanwhile, since the smaller the rigidity of the housing 3, the larger the bending of the housing 3, when the terminal block 1 is fastened to the fixed object 90, the amount of bending of the central portion of the main body portion 31 in the assembling direction Z increases. Therefore, by increasing the difference between the depth of the depth D2 of the end portion in the vicinity of the fastening member 5 and the depth of the depth D1 of the central portion away from the fastening member 5, the pressing force of the packing 4 can be easily made uniform, and the waterproofing by the packing 4 can be appropriately performed.

In the protrusion length of the packing 4 from the accommodation groove 34, a difference (L1-L2) in protrusion length between the protrusion length L1 of the central portion away from the fastening member 5 and the protrusion length L2 of the pressing portion 41 at the end portion in the vicinity of the fastening member 5 is set according to the rigidity of the housing 3. The difference in protrusion length is an absolute value of the difference. For example, in the protrusion length of the packing 4 from the accommodation groove 34, the difference in protrusion length between the protrusion length L1 of the central portion away from the fastening member 5 and the protrusion length L2 of the pressing portion 41 at the end portion in the vicinity of the fastening member 5 is set to be smaller as the rigidity of the housing 3 is higher and larger as the rigidity of the housing is lower. That is, since the bending of the housing 3 decreases as the rigidity of the housing 3 increases, the amount of bending of the central portion of the main body portion 31 in the assembling direction Z decreases when the terminal block 1 is fastened to the fixed object 90 (see an upward arrow in FIG. 4). Therefore, even when the difference in protrusion length between the protrusion length L1 of the central portion away from the fastening member 5 and the protrusion length L2 of the pressing portion 41 at the end portion in the vicinity of the fastening member 5 is small, the pressing force of the packing 4 can be easily made uniform, and the waterproofing by the packing 4 can be appropriately performed. Meanwhile, since the lower the rigidity of the housing 3, the larger the bending of the housing 3, when the terminal block 1 is fastened to the fixed object 90, the amount of bending of the central portion of the main body portion 31 in the assembling direction Z increases. Therefore, by increasing the difference in protrusion length between the protrusion length L1 of the central portion away from the fastening member 5 and the protrusion length L2 of the pressing portion 41 at the end portion in the vicinity of the fastening member 5, the pressing force of the packing 4 can be easily made uniform, and the waterproofing by the packing 4 can be appropriately performed.

Next, assembly of the terminal block 1 according to the present embodiment will be described.

The terminal block 1 according to the present embodiment is assembled to the fixed object 90 by, for example, disposing the terminal block 1 facing the fixed object 90 and fastening the terminal block 1 to the fixed object 90 by the fastening member 5.

In FIGS. 2 and 3, the terminal 2 and the packing 4 are assembled to the housing 3 to form the terminal block 1, and the terminal block 1 is disposed such that the back surface portion 31B of the main body portion 31 of the housing 3 faces the attachment surface 91 of the fixed object 90.

Then, the back surface portion 31B of the main body portion 31 is brought close to the attachment surface 91 of the fixed object 90, and the pressing portion 41 of the packing 4 abuts on the attachment surface 91. In this state, the fastening member 5 is inserted into the fastening hole 33 of the main body portion 31, and fastening is performed by the fastening member 5. The distal end of the fastening member 5 is inserted into the fastening hole 93 of the fixed object 90, and the main body portion 31 is pressed against the fixed object 90 by fastening. Accordingly, the packing 4 is brought into pressure contact with the attachment surface 91 to perform the waterproofing between the fixed object 90 and the housing 3.

In this case, in the terminal block 1 according to the present embodiment, since the protrusion length L1 of the pressing portion 41 at the central portion of the packing 4 away from the fastening member 5 is longer than the protrusion length L2 of the pressing portion 41 at the end portion of the packing 4 in the vicinity of the fastening member 5, it is possible to appropriately perform the waterproofing by the packing 4.

That is, when the terminal block 1 is fastened to the fixed object 90 by the fastening member 5, the main body portion 31 of the housing 3 is strongly pressed against the fixed object 90 at the position of the fastening member 5. As a result, the packing 4 is pressed against the fixed object 90, but the main body portion 31 receives a reaction force from the fixed object 90 via the packing 4. Therefore, as illustrated in FIG. 4, the main body portion 31 may be deformed, and the central portion of the main body portion 31 may be bent in a direction (see an upward arrow in FIG. 4) opposite to the fastening direction. The amount of bending of the main body portion 31 corresponds to the rigidities of the main body portion 31 and the housing 3. For this reason, when the depth of the accommodation groove 34 accommodating the packing 4 is the same along the extending direction, the pressing force on the fixed object 90 is reduced at the central portion of the packing 4, and it becomes difficult to ensure sufficient waterproofing performance.

Meanwhile, in the terminal block 1 according to the present embodiment, as the depth of the accommodation groove 34 is closer to the fastening member 5, the depth is formed deeper and the protrusion length of the packing 4 is shorter, and as the depth is farther from the fastening member 5, the depth is formed shallower and the protrusion length of the packing 4 is longer. Therefore, in the terminal block 1 according to the present embodiment, the pressing force of the packing 4 at a position far from the fastening member 5 can be increased, and the waterproofing by the packing 4 can be appropriately performed. In addition, the terminal block 1 according to the present embodiment can suppress the pressing force of the packing 4 and the reaction force from the fixed object 90 in the vicinity of the fastening member 5, can reduce the strength and rigidity required for the housing 3, and can reduce the size and cost of the housing 3.

Then, as illustrated in FIG. 1, when the terminal block 1 is fastened to the fixed object 90 by the fastening member 5, the assembly of the terminal block 1 to the fixed object 90 is completed.

As described above, in the terminal block 1 according to the present embodiment, the accommodation groove 34 for accommodating the packing 4 is formed deeper as it is closer to the fastening member 5, so that the protrusion length of the pressing portion 41 of the packing 4 is shorter as it is closer to the fastening member 5. Therefore, in the terminal block 1 according to the present embodiment, it is possible to increase the pressing force of the packing 4 at a position far from the fastening member 5 while suppressing the reaction force against the pressing of the packing in the vicinity of the fastening member 5, and it is possible to appropriately perform the waterproofing by the packing 4.

In addition, in the terminal block 1 according to the present embodiment, since the thickness of the packing 4 is formed to be the same in the extending direction, the protrusion length of the pressing portion 41 of the packing 4 can be made shorter as it is closer to the fastening member 5 and longer as it is farther from the fastening member 5. Therefore, in the terminal block 1 according to the present embodiment, it is possible to increase the pressing force of the packing 4 at a position far from the fastening member 5 while suppressing the reaction force from the fixed object 90 in the vicinity of the fastening member 5, and it is possible to appropriately perform the waterproofing by the packing 4.

Note that the terminal block according to the present invention is not limited to the above-described embodiment, and various modifications can be made within the scope described in the claims. The terminal block 1 according to the present embodiment may be configured by appropriately combining the components of the respective embodiments and modifications described above.

For example, although the case where the terminal block 1 according to the above-described embodiment is mounted on a vehicle has been described, the terminal block 1 may be used for an object other than a vehicle.

According to the terminal block of the present embodiment, waterproofing can be appropriately performed by the packing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing that holds a terminal;
a packing that is assembled to the housing and performs waterproofing between the housing and a fixed object; and
a fastening member that fastens the housing to a fixed object,
wherein the packing is accommodated in an accommodation groove formed in the housing, and presses a portion protruding from the accommodation groove against the fixed object to perform the waterproofing, and
the accommodation groove is formed deeper as a depth along a pressing direction of the packing is closer to the fastening member.

2. The terminal block according to claim 1,
wherein the packing is formed to have the same thickness along the pressing direction in the extending direction.
